(19) United States
(12) Patent Application Publication
(10) Pub. No.: US 2010/0035780 A1
(43) Pub. Date: Feb. 11, 2010

(54) COMPOSITIONS AND METHODS FOR DEGREASING AND LUBRICATING

(76) Inventor: JOHN R. TINDALL, OAK PARK, CA (US)

Correspondence Address: STETINA BRUNDA GARRED & BRUCKER, 75 ENTERPRISE, SUITE 250, ALISO VIEJO, CA, 92656, US

(21) Appl. No.: 12/578,873

(22) Filed: Oct. 14, 2009

Related U.S. Application Data
(62) Division of application No. 12/543,426, filed on Aug. 18, 2009.
Application No. 12/543,426 is a continuation of application No. 11/805,913, filed on May 25, 2007, now abandoned.

(51) Int. Cl. C11D 3/20; B21B 45/02; B08B 7/00

(52) U.S. Cl. 508/583; 510/174; 510/365; 134/6

(57) ABSTRACT

Compositions and methods for degreasing and lubricating objects, such as mechanical devices and the like. A composition comprised of a mixture of ethanol and food-grade mineral oil is applied directly to the substrate or objects sought to be degreased or lubricated. For degreasing applications, an amount of the composition is applied in an amount sufficient to penetrate and loosen grease-covered substrates, and is particularly well suited for hand wiping applications. Such methods can also be utilized to remove paint and ink. The compositions are substantially effective yet relatively non-toxic and biodegradable.

### CROSS-REFERENCE TO RELATED APPLICATIONS

The present application is a divisional of U.S. patent application Ser. No. 12/543,426 entitled COMPOSITIONS AND METHODS FOR DEGREASING AND LUBRICATING, filed Aug. 18, 2009, which is a continuation of U.S. patent application Ser. No. 11/805,913 entitled COMPOSITIONS AND METHODS FOR DEGREASING AND LUBRICATING filed May 25, 2007, the teachings of which are incorporated herein by reference.

### STATEMENT RE: FEDERALLY SPONSORED RESEARCH/DEVELOPMENT

Not Applicable

### BACKGROUND

The present invention is directed to novel compositions and methods for degreasing surfaces and lubricating mechanical components, and allows for such methodology to be practiced in a manner that is substantially less toxic and environmentally friendly as compared to prior art methods.

Methods for degreasing are well-known in the art. Essentially, degreasing involves the removal of grease from a surface or substrate that is typically achieved through the use of detergents, alkaline solutions and/or toxic chemical agents such as chromates, phenols, and cresols. Despite their effectiveness, the use of such degreasing agents is highly undesirable due to their toxicity and typically requires special handling, storage and disposal. Indeed, it is well-documented that the use of many conventional degreasers can produce hazardous, volatile compounds when subjected to heat or incineration.

Because of these shortcomings, tremendous effort has been made to develop less toxic and more environment-friendly compounds. With respect to the latter, a significant effort has been made to make degreasers biodegradable, and include citrus-derived cleaning and degreasing products and 2-butoxyethanol based cleaning products as Simple Green® and the like.

Such environment-friendly products, however, despite their minimal toxicity, can often times be problematic due to their ineffectiveness to thoroughly loosen and remove grease from a given surface or material. In this regard, such environment-friendly products contain ingredients that do not work as well as their more toxic predecessors. Such products also frequently contain diluted amounts of their effective ingredients and are thus only effective when utilized at full concentration and/or with multiple applications. As a consequence, the use of such cleaning compositions typically requires greater amounts of labor and time. Accordingly, it would be highly desirable to deploy a degreaser which is both readily biodegradable, has low toxicity but at the same time is just as effective, if not substantially more effective, than conventional degreasing agents.

There is likewise a need in the art for a lubricant possessing the same qualities. In this regard, most lubricants currently in use are petroleum-derived distillates, which include well-known products such as WD-40® that utilize aliphatic petroleum distillates and petroleum based oil. Also exemplary of such products include 3-IN-1 Oil® that comprises severely hydrotreated heavy naphthenic oil, which has become a staple lubricant for stopping squeaks, lubricating wheels and the prevention of stickiness between mechanical parts.

Although effective, the toxicity and harmful effects to the environment posed by prior art lubricants can make such products undesirable. Accordingly, in addition to degreasing, there is a further need in the art for methods or lubricating mechanical components that do not pose the disadvantages discussed herein with respect to toxicity and potential harm to the environment. There is a further need in the art for such novel ways of degreasing and lubricating that are substantially effective, easy to apply, of simple formulation, are relatively inexpensive, and pose no harm to the environment as compared to conventional methods and materials utilized for degreasing and lubrication.

### BRIEF SUMMARY

The present invention specifically addresses and alleviates the above-identified deficiencies in the art. In this regard, the present invention is directed to methods for degreasing and lubricating via the use of compositions that are relatively non-toxic, biodegradable and substantially more effective in removing grease and lubricating mechanical components than prior art compositions. To that end, the methods of the present invention contemplate the use of compositions comprised of a mixture of ethanol in combination with food-grade mineral oil. Such compositions may preferably take the form of those compositions disclosed in U.S. Pat. No. 6,663,830, to the Applicant, John Tindall, issued Dec. 16, 2003 entitled WOOD CONDITIONER WITH ANTISEPTIC PROPERTIES, the teachings of which are expressly incorporated herein by reference. Per the teachings of Applicant's earlier reference, the ethanol component may be present in an amount from 40% to 99% by volume, with the mineral oil being present in an amount from 60% to 1% by volume. For use in practicing the degreasing and lubrication methods disclosed herein, the composition preferably comprises 85% to 97% by volume ethanol and 3% to 15% by volume mineral oil. In a more highly preferred embodiment, the ethanol component is present in an amount ranging from 96% to 92% by volume and the mineral oil component is present in an amount of 4% to 8% by volume. In a most highly preferred embodiment, the ethanol component is present in an amount of approximately 94% by volume and the mineral oil is present in the amount of approximately 6% by volume. To the extent desired, additional components may be added, such as a scent, preservative, buggering agent, anti-oxidant, coloring agent, to name a few. Water may additionally be added to the extent necessary to produce a desired concentration of the composition.

With respect to the use of such composition for degreasing methods, it is contemplated that a composition of the aforementioned formulation need only to be applied directly to the surface of a substrate from which grease is to be removed. This may be accomplished simply by spraying, pouring or otherwise applying the compositions directly upon the substrate and allowing the composition to loosen and suspend the grease, after which time the grease can be removed by wiping and the like.

Similarly, with respect to the methods for lubricating, the same merely comprise directly applying the aforementioned composition, whether by pouring, spraying, and the like, directly to the surfaces to be lubricated, for example a hinge, sprocket or any of a variety of mechanical components. Once sufficiently saturated upon such surface, the compositions will be operative to protect and facilitate the movement between moving mechanical parts, per conventional lubricants. Advantageously, however, methods of using the compositions for such purposes will result in lubricious interface between the mechanical components to which the composition is applied, but will do so in a manner that is non-toxic and biodegradable, as compared to the use of conventional petroleum distillate solvents.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

The present invention is directed to methods for degreasing a surface or substrate contaminated with grease, as well as methods for lubricating a surface, and in particular one or more mechanical components so as to impart a protective coating, reduce friction/noise, and other like purposes well-known in the art. Methods disclosed herein are operative to achieve such objectives in a manner that is substantially less toxic and less harmful to the environment as compared to other prior art methods. There are further disclosed compositions for achieving that end.

To practice the present invention requires the use of a composition comprised of a mixture of food-grade mineral oil and ethanol. Along these lines, the compositions as utilized herein for both degreasing and lubricating methods may take the form of those compositions disclosed in U.S. Pat. No. 6,663,830, issued to Applicant on Dec. 16, 2003 entitled WOOD CONDITIONER WITH ANTISEPTIC PROPERTIES, the teachings of which are expressly incorporated herein by reference. In this respect, the basic two (2) components will preferably have the respective percentages by volume thereof in the following ranges:

TABLE 1

| COMPONENTS | PERCENT BY VOLUME |
|---|---|
| Ethanol | 40% to 99% |
| Mineral Oil | 60% to 01% |

It is to be understood that the percentages of the two (2) components above will total 100% by volume. If other materials are included in the formulation, the percentages of all ingredients will obviously total 100% by volume.

The ethanol component preferably comprises commercially-available, high grade ethyl alcohol, and may constitute such grades known in the art as grain alcohol or high-purity alcohol. Optionally, such commercially-available alcohol may include denaturants, such as methyl alcohol, pyridine, benzene, pine oil, benzene, and hydrogenated organic compounds, typically added to ethanol to ensure non-beverage/non-food usage as may be desired.

The mineral oil component will likewise optionally be of a high-grade, commercially-available variety. The mineral oil component will be suitable for human consumption so as to minimize any potential toxicity associated with the methods herein. Accordingly, any reputable food grade mineral oil currently available that may be procured commercially may be utilized in the practice of the present invention.

In a preferred embodiment, as shown in Table 2, the respective percentages by volume of the two (2) components of the composition of the present invention:

TABLE 2

| COMPONENTS | PERCENT BY VOLUME |
|---|---|
| Ethanol | 97% to 85% |
| Mineral Oil | 3% to 15% |

In a more highly refined embodiment, there is shown in Table 3, the respective percentages by volume of the two (2) components of the composition of the present invention:

TABLE 3

| COMPONENTS | PERCENT BY VOLUME |
|---|---|
| Ethanol | 96% to 92% |
| Mineral Oil | 8% to 4% |

As discussed above, both components, namely, the ethanol and mineral oil will be of high-grade quality and optionally can be made suitable for human consumption.

In a most highly preferred embodiment, there is shown in Table 4 the respective percentages by volume of the two (2) components of the present invention:

TABLE 4

| COMPONENTS | PERCENT BY VOLUME |
|---|---|
| Ethanol approximately | 94% |
| Mineral Oil approximately | 6% |

Again, both components will be of commercial, high-grade quality. Along these lines, with respect to the ethanol component, the same will be of beverage quality and devoid of any denaturants.

Although not essential, it is further contemplated that adjuvants may be added to further enhance the performance or stabilize the basic two (2) component formulation. Representative examples include buffering agents that buffer within a desired pH range, anti-oxidants, sequestering agents, preservatives, fragrances, flavor enchanters, and/or coloring agents. Likewise, as may be necessary to achieve a certain formulation, it is contemplated that water may additionally be added as component, particularly with respect to the ethanol component, to thus enable the same to remain present at a fixed amount of volume. Along these lines, it is contemplated that water may be present in an amount from 0% up to 55% by volume of the resultant compositions.

As will be appreciated by those skilled in the art, the composition of the present invention advantageously omits the use of any toxic chemicals typically found in most cleaning solutions for use as degreasers and lubricating agents. Indeed, most cleaning preparations currently in use, albeit effective, pose a threat in and of themselves by introducing toxic agents, such as chromates, phenols, petroleum-derived solvents, and the like, which can come into contact not only with the person handling and using such agents, but also can become released into the environment thus posing a threat of pollution.

For degreasing applications, the aforementioned compositions need only be applied to surfaces or substrates contaminated with grease for the same to be removed. The composition can be applied through any of a variety of means known in the art, such as by spraying, pouring, and the like, or may be applied with an applicator such as a brush, roller and the like. Advantageously, the alcohol and mineral oil components are operative to loosen and suspend the grease from the surface or substrate. To allow for thorough loosening, it is contemplated that a sufficient duration of time should be allowed, such as 30 seconds to over one minute, to thus enable the ethanol/mineral oil composition to thoroughly loosen and suspend the grease from the surface/substrate. Once the grease has been sufficiently loosened from the contaminated surface, as may be determined by visual inspection and the like, the same may be removed therefrom, typically by hand wiping and the like. Advantageously, the mineral oil/ethanol composition is not only effective in removing grease, but is further operative to provide disinfectant properties via the ethanol component. As is well-known, ethanol alcohol has been widely used as a disinfecting agent. Moreover, any residual mineral oil/ethanol remaining will be substantially less toxic than conventional degreasers discussed above and likewise will be biodegradable and thus pose no threat to the environment. Furthermore, the methods for degreasing do not require that the compositions used to facilitate that end be handled in any special manner and likewise do not require any special type of storage or disposal considerations.

Moreover, in addition to facilitating the removal of grease, it has further been appreciated that the compositions and methods of the present invention can be utilized in related applications such as paint and ink removal. Indeed, it has unexpectedly been found that the compositions and methods of the present invention are exceptionally effective in removing “permanent” markings and can be utilized to clean professional paint sprayers and readily remove paint from brushes, rollers and the like. As will be readily appreciated, compositions of the present invention, due to their minimal toxicity and biodegradability, are superior when compared to more toxic alternatives such as paint thinners, mineral spirits, and the like. Along these lines, it is contemplated that the compositions of the present invention and methods of using the same can be utilized to remove paint, and in particular spray paint, from non-porous surfaces, and in particular windows.

With respect to methods for lubricating, it is contemplated that the aforementioned compositions may be applied directly to the surface of the components/objects sought to be lubricated. To that end, it is contemplated that the compositions need only sprayed, poured or applied via an application tool, such as a brush, roller and the like, such that a sufficient layer of the composition is deposited upon the surface sought to be lubricated. In this respect, it is contemplated that the method for lubricating disclosed herein can take the form or any of a variety of conventional methods as used with toxic compositions, such as WD-40®, 3-IN-1 Oil® and other petroleum-derived lubricants.

In use, the methods disclosed herein may be utilized for a variety of applications. For example, it is contemplated that the present invention can be utilized to degrease hand tools, cooking surfaces, grease-contaminated components, such as automotive parts, and the like, as well as facilitate the removal of paint from painting equipment. Likewise, with respect to lubricating applications, it is contemplated that the present invention can be utilized for virtually all types of mechanical components, including hinges, sprockets, chains, springs, pulleys, and any other type of componentry or surface where it is advantageous to apply a lubricating composition.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

What is claimed is:

1. A method for removing grease from a surface contaminated therewith, the method comprising the steps:
a. providing a composition consisting of mineral oil present in an amount of 1% to 60% by volume of the composition and ethanol present in an amount from 40% to 99% by volume of the composition;
b. contacting said surface with said composition provided for in step a);
c. providing sufficient time to enable said composition to loosen said grease from said surface; and
d. removing said loosened grease from said substrate.

2. The method of claim 1 wherein in step a), said composition comprises mineral oil present in an amount ranging form 4% to 8% by volume of said compositions and said ethanol is present in an amount ranging from 96% to 92% by volume of said composition.

3. The method of claim 1 wherein in step a), said composition comprises mineral oil present in an amount of approximately 6% by volume of said compositions and said ethanol is present in an amount of approximately 94% by volume of said composition.

4. The method of claim 1 wherein step d) comprises hand wiping said substrate to remove said loosened grease from said substrate.

5. The method of claim 1 wherein step b) comprises contacting said surface with said composition via an application process selected from the group consisting of spraying, pouring, brushing and rolling.

6. The method of claim 1 wherein in step a), said composition further comprises a denaturant.

7. A method for lubricating the surface of a component, said method comprising the steps:
a. providing a composition consisting of mineral oil present in an amount of 1% to 60% by volume of the composition and ethanol present in an amount from 40% to 99% by volume of the composition; and
b. contacting said surface of said component with said composition provided for in step a).

8. The method of claim 1 wherein in step a), said composition comprises mineral oil present in an amount ranging form 4% to 8% by volume of said composition and said ethanol is present in an amount ranging from 96% to 92% by volume of said composition.

9. The method of claim 1 wherein in step a), said composition comprises mineral oil present in an amount of approximately 6% by volume of said compositions and said ethanol is present in an amount of approximately 94% by volume of said composition.

10. The method of claim 1 wherein step b) comprises contacting said surface with said composition via an application process selected from the group consisting of spraying, pouring, brushing and rolling.

11. The method of claim 1 wherein in step a), said composition further comprises a denaturant.

12. The method of claim 1 wherein the method is directed to removing paint from a surface contaminated therewith; step c) comprises providing sufficient time to enable said composition to loosen said paint from said surface; and step d) comprises removing said loosened paint from said substrate.

13. The method of claim 1 wherein the method is directed to removing ink from a surface contaminated therewith; step c) comprises providing sufficient time to enable said composition to loosen said ink from said surface; and step d) comprises removing said loosened ink from said substrate.
